(19) United States
(12) Patent Application Publication
(10) Pub. No.: US 2022/0036730 A1
(43) Pub. Date: Feb. 3, 2022

(54) DANGEROUS DRIVING DETECTION DEVICE, DANGEROUS DRIVING DETECTION SYSTEM, DANGEROUS DRIVING DETECTION METHOD, AND STORAGE MEDIUM

(71) Applicant: TOYOTA JIDOSHA KABUSHIKI KAISHA, Toyota-shi (JP)

(72) Inventors: Kenki UEDA, Shinagawa-ku (JP); Ryosuke TACHIBANA, Shinagawa-ku (JP); Shinichiro KAWABATA, Ota-ku (JP); Takashi KITAGAWA, Kodaira-shi (JP); Hirofumi OHASHI, Chiyoda-ku (JP); Toshihiro YASUDA, Osaka-shi (JP); Tetsuo TAKEMOTO, Edogawa-ku (JP)

(73) Assignee: TOYOTA JIDOSHA KABUSHIKI KAISHA, Toyota-shi (JP)

(21) Appl. No.: 17/305,673

(22) Filed: Jul. 13, 2021

(30) Foreign Application Priority Data
Jul. 31, 2020 (JP) 2020-131223

(51) Int. Cl. G08G 1/04; G06K 9/00; G06K 9/62

(52) U.S. Cl. CPC G08G 1/04; G06K 9/6288; G06K 9/00791

(57) ABSTRACT

A dangerous driving detection device includes: an acquisition section that acquires image information, which expresses captured images that are captured by an imaging section provided at a vehicle, and vehicle information that expresses a state of the vehicle; plural detection sections that, based on the image information and the vehicle information acquired by the acquisition section, detect types of dangerous driving that are respectively different from one another; and a deriving section that, based on results of detection of the plural detection sections, derives a degree of danger of dangerous driving of a driver.

### CROSS-REFERENCE TO RELATED APPLICATION

This application is based on and claims priority under 35 USC 119 from Japanese Patent Application No. 2020-131223 filed on Jul. 31, 2020, the disclosure of which is incorporated by reference herein.

### BACKGROUND

### Technical Field

The present disclosure relates to a dangerous driving detection device, a dangerous driving detection system, a dangerous driving detection method, and a storage medium that stores a program for detecting dangerous driving by a driver.

### Related Art

Japanese Patent No. 5179686 discloses a device for computing a degree of danger of driving behavior that computes and outputs a driving behavior danger degree. The device detects, for respective objects in the peripheral environment of the vehicle, the orientation thereof with respect to the traveling direction of the vehicle, the speed thereof, and the relative position thereof with respect to the vehicle, and computes an environment danger degree for each of the objects. The device further detects the viewing actions of the driver. The device computes a driving behavior danger degree on the basis of the environment danger degree of each object, and a weighting factor that corresponds to the viewing actions of the driver with respect to each object and that is determined per object on the basis of the viewing actions of the driver.

Although Japanese Patent No. 5179686 computes the driving behavior danger degree is computed on the basis of the environment danger degree per object and weighting factors that correspond to the viewing actions of the driver, only the degree of danger of one type of driving behavior is computed. Therefore, it is only possible to detect degrees of danger with respect to some types of dangerous driving as dangerous driving of the driver, and there is room for improvement in order to evaluate the actual dangerous driving of the driver.

### SUMMARY

The present disclosure provides a dangerous driving detection device, a dangerous driving detection system, a dangerous driving detection method, and a storage medium storing a program that may more properly evaluate actual dangerous driving by a driver, as compared with a case in which the degree of danger of driving behavior is computed on the basis of the environment danger degree per object and weighting factors that correspond to the viewing actions of the driver with respect to the objects.

A first aspect of the present disclosure is a dangerous driving detection device including: an acquisition section that acquires image information, which expresses captured images that are captured by an imaging section provided at a vehicle, and vehicle information that expresses a state of the vehicle; plural detection sections that, based on the image information and the vehicle information acquired by the acquisition section, detect types of dangerous driving that are respectively different from one another; and a deriving section that, based on results of detection of the plural detection sections, derives a degree of danger of dangerous driving of a driver.

In accordance with the dangerous driving detection device of the first aspect, image information, which expresses captured images captured by an imaging section provided at a vehicle, and vehicle information that expresses a state of the vehicle, are acquired by the acquisition section. For example, image data of a video image in which the vehicle periphery is captured is acquired as the image information. Further, examples of the acquired vehicle information include position information, vehicle speed, acceleration, steering angle, accelerator position, distances to obstacles at the periphery of the vehicle, the route and the like.

The plural detection sections detect different types of dangerous driving from one another, based on the image information and the vehicle information acquired by the acquisition section.

Further, at the deriving section, the degree of danger of dangerous driving of the driver is derived based on results of detection of the plural detection sections. Due thereto, the degree of danger of the dangerous driving of the driver may be derived from types of dangerous driving that are detected multilaterally. Therefore, actual dangerous driving by a driver may be evaluated more properly, as compared with a case in which the degree of danger of driving behavior is computed on the basis of the environment danger degree per object and weighting factors that correspond to the viewing actions of the driver with respect to the objects.

Note that each of the plural detection sections may identify a traveling scenario based on the image information and the vehicle information, and detect dangerous driving that corresponds to the identified traveling scenario. Due thereto, dangerous driving may be detected by also including the situation at the time of traveling.

Further, the detection section may change a detection threshold value, which is for detection of dangerous driving, to a predetermined detection threshold value in accordance with the traveling scenario, to detect the dangerous driving. Due thereto, detection of dangerous driving that is in accordance with the situation at the time of traveling is possible.

Further, the traveling scenario may include at least one of type of road, weather, time range, or accident occurrence rate at a place of traveling. Due thereto, detection of dangerous driving that is in accordance with at least one traveling scenario of the type of road, weather, time range, and accident occurrence rate at the place of traveling, is possible.

The acquisition section may carry out synchronization processing of the image information and the vehicle information by performing time matching of the image information and the vehicle information. Due thereto, dangerous driving may be detected base on the image information and the vehicle information being made to correspond to one another.

A second aspect of the present disclosure is a dangerous driving detection system that includes: the dangerous driving detection device of the first aspect; and a vehicle that includes the imaging section and a vehicle information detection section that detects the vehicle information.

A third aspect of the present disclosure is a dangerous driving detection method including: acquiring image information, which expresses captured images that are captured by an imaging section provided at a vehicle, and vehicle information that expresses a state of the vehicle; based on the acquired image information and the acquired vehicle information, detecting types of dangerous driving that are respectively different from one another; and, based on results of detection, deriving a degree of danger of dangerous driving of a driver.

A fourth aspect of the present disclosure is a non-transitory storage medium that stores a program that is executable by a computer to perform dangerous driving detection processing, the dangerous driving detection processing including: acquiring image information, which expresses captured images that are captured by an imaging section provided at a vehicle, and vehicle information that expresses a state of the vehicle; based on the acquired image information and the acquired vehicle information, detecting types of dangerous driving that are respectively different from one another; and based on results of detection, deriving a degree of danger of dangerous driving of a driver.

As described above, in accordance with the present disclosure, a dangerous driving detection device, a dangerous driving detection system, a dangerous driving detection method, and a storage medium may be provided that enable more proper evaluation of actual dangerous driving by a driver, as compared with a case in which the degree of danger of driving behavior is computed on the basis of weighting factors that correspond to the viewing actions of the driver with respect to the objects.

### BRIEF DESCRIPTION OF THE DRAWINGS

FIG. 1 is a drawing illustrating the schematic structure of a dangerous driving detection system relating to a present embodiment.

FIG. 2 is a functional block drawing illustrating the functional structures of onboard equipment and a dangerous driving data aggregation server in the dangerous driving detection system relating to the present embodiment.

FIG. 3 is a block drawing illustrating the structures of a control section and a central processing section.

FIG. 4 is a drawing for explaining an example of weighting and threshold value changing in accordance with a traveling scenario.

FIG. 5 is a flowchart illustrating an example of the flow of processing carried out at the dangerous driving data aggregation server in the dangerous driving detection system relating to the present embodiment.

FIG. 6 is a functional block drawing illustrating a modified example of the functional structures of the onboard equipment and the dangerous driving data aggregation server in the dangerous driving detection system relating to the present embodiment.

### DETAILED DESCRIPTION

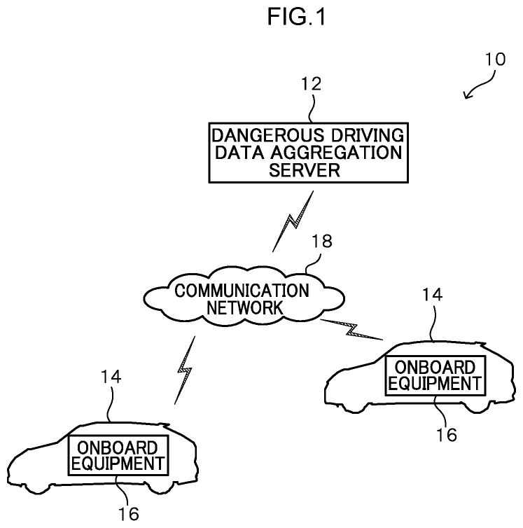

An embodiment of the present disclosure is described in detail hereinafter with reference to the drawings. FIG. 1 is a drawing illustrating the schematic structure of a dangerous driving detection system relating to the present embodiment.

In a dangerous driving detection system 10 relating to the present embodiment, onboard equipment 16 that are installed in vehicles 14, and a dangerous driving data aggregation server 12 that serves as a dangerous driving detection device, are connected via a communication network 18. In the dangerous driving detection system 10, image information that is obtained by the capturing of images by the plural onboard equipment 16, and vehicle information that expresses the states of the respective vehicles, are transmitted to the dangerous driving data aggregation server 12, which accumulates the image information and the vehicle information. Then, on the basis of the accumulated image information and vehicle information, the dangerous driving data aggregation server 12 carries out processing of detecting dangerous driving. In the present embodiment, types of dangerous driving such as: dangerous driving of at least one of sudden acceleration of sudden deceleration, dangerous driving that is non-maintenance of the inter-vehicle distance, dangerous driving that is obstructing a pedestrian, dangerous driving that is speeding, are detected as examples of the dangerous driving to be detected.

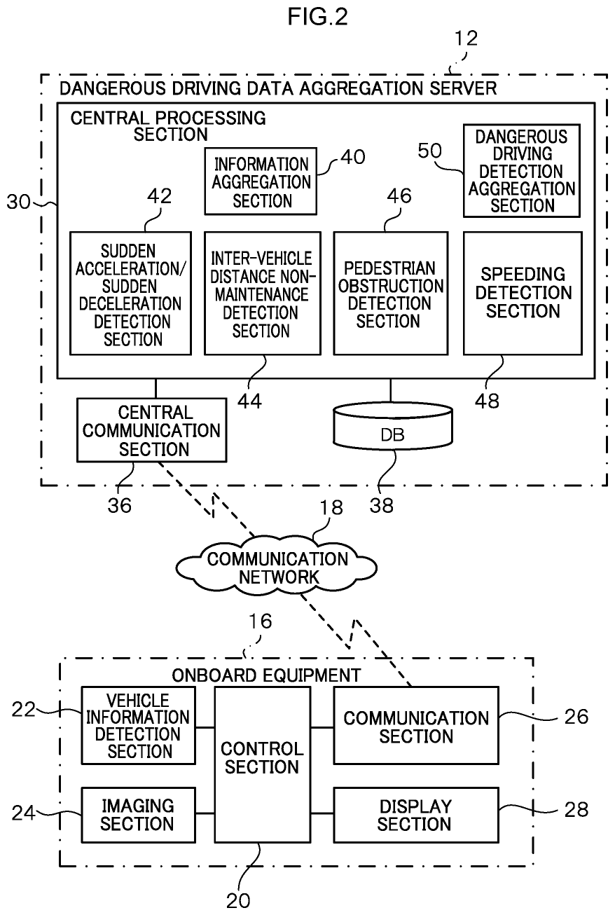

FIG. 2 is a functional block drawing that illustrates the functional structures of the onboard equipment 16 and the dangerous driving data aggregation server 12 in the dangerous driving detection system 10 relating to the present embodiment.

The onboard equipment 16 includes a control section 20, a vehicle information detection section 22, an imaging section 24, a communication section 26, and a display section 28.

The vehicle information detection section 22 detects vehicle information that relates to the vehicle 14. For example, vehicle information such as position information, vehicle speed, acceleration, steering angle, accelerator position, distances to obstacles at the periphery of the vehicle, the route and the like of the vehicle 14 are detected as examples of the vehicle information. Specifically, the vehicle information detection section 22 may utilize plural types of sensors and devices that acquire information expressing a situation of the peripheral environment of the vehicle 14. Examples of the sensors and devices include sensors that are installed in the vehicle 14 such as a vehicle speed sensor, an acceleration sensor and the like, and a Global Navigation Satellite System (GNSS) device, an onboard communicator, a navigation system, a radar device and the like. A GNSS device receives GNSS signals from plural GNSS satellites and measures the position of the vehicle 14. The accuracy of measurement of the GNSS device increases as the number of GNSS signals that may be received increases. The onboard communicator is a communication device that carries out at least one of vehicle-to-vehicle communication with the other vehicles 14 or road-to-vehicle communication with roadside devices, via the communication section 26. The navigation system includes a map information storage section that stores map information. On the basis of the position information obtained from the GNSS device and the map information stored in the map information storage section, the navigation system carries out processings such as displaying the position of the vehicle 14 on a map, and guiding the vehicle 14 along the route to the destination. Further, the radar device includes plural radars that have respectively different detection ranges, and detects objects such as pedestrians and the other vehicles 14 that exist at the periphery of the local vehicle 14, and acquires the relative positions and the relative speeds of the local vehicle 14 and the detected objects. The radar device incorporates therein a processing device that processes the results of detection of objects at the periphery. On the basis of information such as changes in the relative positions and the relative speeds of the individual objects that are included in the detection results of the most recent several times, the processing device excludes, from objects of monitoring, noise, roadside objects such as guardrails and the like, and tracks pedestrians and the other vehicles 14 as objects of monitoring. The radar device outputs information such as the relative positions and the relative speeds with respect to the individual objects of monitoring.

In the present embodiment, the imaging section 24 is installed in the vehicle and captures images of the vehicle periphery such as the front of the vehicle, and generates image data that expresses captured images that are video images. For example, a camera such as a driving recorder or the like may be used as the imaging section 24. Note that the imaging section 24 may further capture images of the vehicle periphery at at least one of the lateral sides or the rear side of the vehicle 14. Further, the imaging section 24 may further capture images of the vehicle cabin interior.

The communication section 26 establishes communication with the dangerous driving data aggregation server 12 via the communication network 18, and carries out transmission and reception of information such as image information obtained by the imaging by the imaging section 24, vehicle information detected by the vehicle information detection section 22, and the like.

The display section 28 provides various information to the vehicle occupants by displaying information. In the present embodiment, information that is provided from the dangerous driving data aggregation server 12 are displayed.

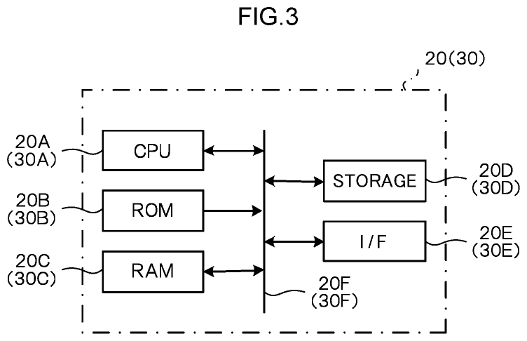

As illustrated in FIG. 3, the control section 20 is structured by a general microcomputer that includes a Central Processing Unit (CPU) 20A, a Read Only Memory (ROM) 20B, a Random Access Memory (RAM) 20C, a storage 20D, an interface (I/F) 20E, a bus 20F and the like. The control section 20 carries out control to upload, to the dangerous driving data aggregation server 12, image information that expresses the images captured by the imaging section 24, and vehicle information detected by the vehicle information detection section 22 at the time of capturing the images, as well as other various types of control.

The dangerous driving data aggregation server 12 includes a central processing section 30, a central communication section 36, and a database (DB) 38.

As illustrated in FIG. 3, the central processing section 30 is structured by a general microcomputer that includes a CPU 30A, a ROM 30B, a RAM 30C, a storage 30D, an interface (I/F) 30E, a bus 30F and the like. The central processing section 30 has the functions of an information aggregation section 40, a sudden acceleration/sudden deceleration detection section 42, a detection section 44 of non-maintenance of an inter-vehicle distance (i.e., inter-vehicle distance non-maintenance detection section 44), a detection section 46 of pedestrian obstruction (i.e., pedestrian obstruction detection section 46), a speeding detection section 48, and a dangerous driving detection aggregation section 50. Note that these respective functions of the central processing section 30 are realized by the CPU 30A executing a program that is stored in the ROM 30B, for example. Further, the information aggregation section 40 corresponds to an example of the acquisition section. The sudden acceleration/sudden deceleration detection section 42, the inter-vehicle distance non-maintenance detection section 44, the pedestrian obstruction detection section 46 and the speeding detection section 48 correspond to examples of the plural detection sections. Further, the dangerous driving detection aggregation section 50 corresponds to an example of the deriving section.

The information aggregation section 40 acquires, from the DB 38, the vehicle information such as the vehicle speed, acceleration, position information and the like, and video frames that are image information captured by the imaging section 24. The information aggregation section 40 carries out processing such as time matching on the vehicle information and the video frames, and aggregates information while synchronizing the vehicle information and the video frames with one another. Note that, in the following description, there are cases in which the information that has been aggregated is referred to as the aggregated information.

On the basis of the aggregated information aggregated by the information aggregation section 40, the sudden acceleration/sudden deceleration detection section 42 detects dangerous driving of at least one of sudden acceleration or sudden deceleration. For example, the sudden acceleration/sudden deceleration detection section 42 detects dangerous driving of at least one of sudden acceleration or sudden deceleration by, on the basis of the image information and the vehicle information, detecting whether the vehicle speed or the acceleration corresponds to a predetermined type of dangerous driving, and whether the situation at the periphery of the vehicle corresponds to dangerous driving. Alternatively, the sudden acceleration/sudden deceleration detection section 42 may detect vehicle speed and acceleration that correspond to predetermined types of dangerous driving by using only the vehicle information.

On the basis of the aggregated information that has been aggregated by the information aggregation section 40, the inter-vehicle distance non-maintenance detection section 44 detects dangerous driving of non-maintenance of an inter-vehicle distance, in which the distance between vehicles is a predetermined distance or less. For example, the inter-vehicle distance non-maintenance detection section 44 detects dangerous driving of non-maintenance of an inter-vehicle distance by, on the basis of the image information and the vehicle information, detecting a vehicle in front, and detecting that the distance to the vehicle in front from the local vehicle 14 is a predetermined distance or less.

On the basis of the aggregated information that has been aggregated by the information aggregation section 40, the pedestrian obstruction detection section 46 detects the dangerous driving of obstructing a pedestrian. For example, the pedestrian obstruction detection section 46 detects the dangerous driving of obstructing a pedestrian by, on the basis of the image information and the vehicle information, detecting a pedestrian ahead who is in a crosswalk and/or who satisfies a predetermined condition, and detecting whether the vehicle 14 is passing through without stopping or going slowly. For example, a pedestrian who is the midst of crossing a crosswalk, a pedestrian who is in the vicinity of a crosswalk, or a pedestrian who is about to start walking into a crosswalk are detected as a pedestrian who satisfies a predetermined condition.

The speeding detection section 48 detects the dangerous driving of speeding, on the basis of the aggregated information that has been aggregated by the information aggregation section 40. For example, the speeding detection section 48 detects the dangerous driving of speeding by, on the basis of the image information and the vehicle information, recognizing a traffic sign by image recognition, and detecting a vehicle speed that is greater than or equal to a predetermined speed from the speed limit of the recognized traffic sign. Alternatively, the speeding detection section 48 may judge whether the vehicle 14 is on a general road or on a highway based on the position information, and may detect that the vehicle speed is a predetermined vehicle speed or higher on each type of road.

The dangerous driving detection aggregation section 50 aggregates the dangerous driving detected respectively by the sudden acceleration/sudden deceleration detection section 42, the inter-vehicle distance non-maintenance detection section 44, the pedestrian obstruction detection section 46 and the speeding detection section 48, and comprehensively judges overall dangerous driving. For example, at the time of detecting each type of dangerous driving, the degree of danger thereof may be computed in a range of 0 to 1, the average of the degrees of danger of the respective types of dangerous driving may be computed, and, if the average value is greater than or equal to a predetermined threshold value, the dangerous driving detection aggregation section 50 may comprehensively determine that whether there is dangerous driving. Alternatively, the absence/presence of the detection of each type of dangerous driving may be detected as 0 (i.e., not detected) or 1 (i.e., detected), and the total of the detection results may be derived as the overall degree of danger. Alternatively, at the time of detecting each type of dangerous driving, a score for each type of dangerous driving may be derived, the total of the scores may be computed, and the dangerous driving detection aggregation section 50 may judge that there is overall dangerous driving if the total score is greater than or equal to a predetermined threshold value. Alternatively, in detecting each type of dangerous driving, non-detection may be detected as 0, detection may be detected as 1, the results of detection of the respective types of dangerous driving may be totaled, and the dangerous driving detection aggregation section 50 may judge that there is overall dangerous driving if the total is greater than or equal to 1, or greater than or equal to a predetermined threshold value.

Further, in the present embodiment, at the time of detecting each of the four types of dangerous driving, a traveling scenario is identified based on the aggregated information, and the detection threshold values and weights of the types of dangerous driving are changed in accordance with the traveling scenario, to detect dangerous driving that corresponds to the traveling scenario.

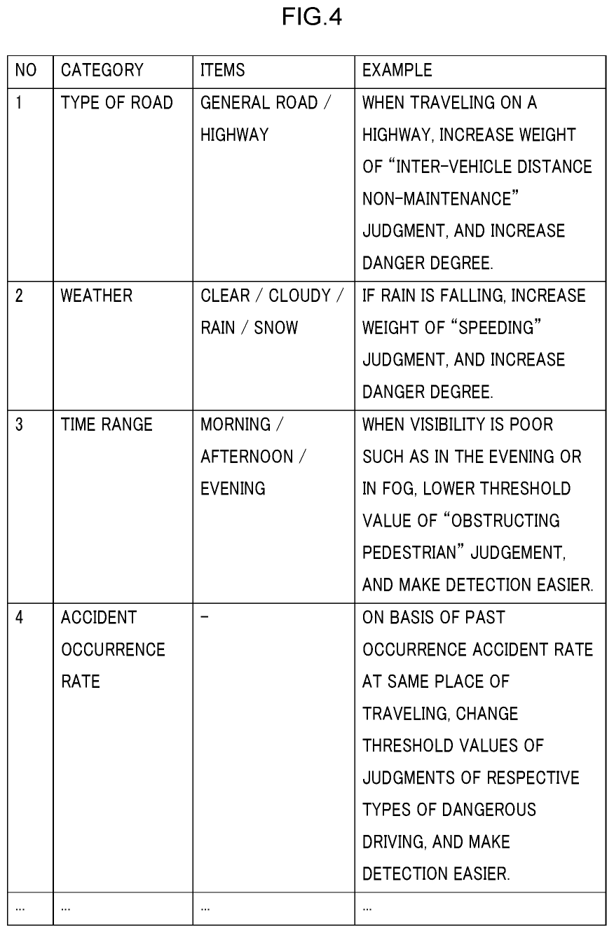

FIG. 4 is a drawing for explaining an example of changing the weights and threshold values in accordance with the traveling scenario. For example, as illustrated in FIG. 4, the traveling scenarios are classified into type of road, weather, time range, accident occurrence rate, and the like. The types of roads are classified into general road and highway. For example, the weight of the judgement of “non-maintenance of inter-vehicle distance” when traveling on a highway is increased, and the degree of danger is increased. The weather is classified into clear, cloudy, rain and snow. For example, in a case in which rain is falling, the weight of the judgment of “speeding” is increased, and the degree of danger is increased. The time range is classified into morning, afternoon and evening. The detection threshold value for “obstructing a pedestrian” at times when visibility is poor such as in the evening or when it is foggy or the like is reduced (e.g., the threshold value of the vehicle speed is lowered from 20 km/h or less to 10 km/h, or the like) to make detection easier. With respect to the accident occurrence rate, for example, the detection threshold value of each type of dangerous driving is changed on the basis of past occurrence accident rates at the same place of traveling, and detection is made easier. Note that, in the case of a traveling scenario of a combination of the items of FIG. 4, the weight may be further increased. For example, in the case in which the weather is rainy and the time range is evening, the weight of the dangerous driving may be increased and/or the threshold value for judging dangerous driving may be lowered so as to make detection easier.

The central communication section 36 establishes communication with the onboard equipment 16 via the communication network 18, and carries out transmission and reception of information such as image information, vehicle information and the like.

The DB 38 receives image information and vehicle information from the onboard equipment 16, and accumulates the received image information and vehicle information by associating them with each other.

In the dangerous driving detection system 10 that is structured as described above, the image information that is captured by the imaging section 24 of the onboard equipment 16 is transmitted, together with the vehicle information, to the dangerous driving data aggregation server 12, and is accumulated in the DB 38.

The dangerous driving data aggregation server 12 carries out processing of detecting dangerous driving on the basis of the image information and the vehicle information accumulated in the DB 38. Further, the dangerous driving data aggregation server 12 provides various types of services such as the service of feeding-back the dangerous driving detection results to the driver.

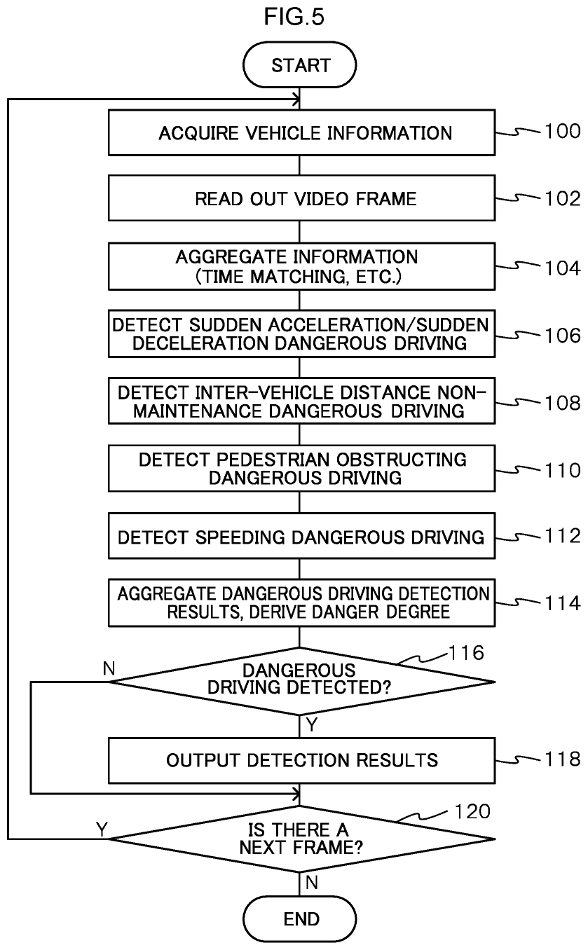

Next, specific processing that is carried out by the dangerous driving data aggregation server 12 of the dangerous driving detection system 10 relating to the present embodiment that is structured as described above will be described. FIG. 5 is a flowchart illustrating an example of the flow of processing that is carried out at the dangerous driving data aggregation server 12 in the dangerous driving detection system 10 relating to the present embodiment. Note that, for example, the processing of FIG. 5 starts each predetermined time period, or each time that the amount of vehicle information and image information, which have been transmitted from the onboard equipment 16 and are stored in the DB 38, becomes a predetermined data amount or more. Specifically, the respective sections of the central processing section 30 operate as follows due to the CPU 30A executing a program that is stored in the ROM 30B or the like.

In step 100, the information aggregation section 40 acquires vehicle information from the DB 38, and the routine moves on to step 102.

In step 102, the information aggregation section 40 reads out video frames from the DB 38, and the routine moves on to step 104.

In step 104, the information aggregation section 40 carries out time matching or the like of the vehicle information and the video frames, and aggregates information by synchronizing the vehicle information and the video frames with one another, and the routine moves on to step 106.

In step 106, on the basis of the aggregated information that has been aggregated by the information aggregation section 40, the sudden acceleration/sudden deceleration detection section 42 detects the dangerous driving of sudden acceleration/sudden deceleration that corresponds to at least one type of dangerous driving of sudden acceleration or sudden deceleration, and the routine moves on to step 108. In a case in which the dangerous driving of sudden acceleration/sudden deceleration is detected, dangerous driving corresponding to the traveling scenario is detected.

In step 108, on the basis of the aggregated information that has been aggregated by the information aggregation section 40, the inter-vehicle distance non-maintenance detection section 44 detects dangerous driving of non-maintenance of an inter-vehicle distance, in which the distance between vehicles is a predetermined distance or less, and the routine moves on to step 110. Also for dangerous driving of non-maintenance of an inter-vehicle distance, dangerous driving corresponding to the traveling scenario is detected.

In step 110, on the basis of the aggregated information that has been aggregated by the information aggregation section 40, the pedestrian obstruction detection section 46 detects the dangerous driving of pedestrian obstruction that is obstructing a pedestrian, and the routine moves on to step 112. Also for dangerous driving of pedestrian obstruction, dangerous driving corresponding to the traveling scenario is detected.

In step 112, on the basis of the aggregated information that has been aggregated by the information aggregation section 40, the speeding detection section 48 detects the dangerous driving of speeding, and the routine moves on to step 114. Also for dangerous driving that is speeding, dangerous driving corresponding to the traveling scenario is detected. Note that the order of the processings of steps 106 through 112 is not limited to this, and the processings may be carried out in a different order.

In step 114, the dangerous driving detection aggregation section 50 aggregates the dangerous driving that are detected respectively by the sudden acceleration/sudden deceleration detection section 42, the inter-vehicle distance non-maintenance detection section 44, the pedestrian obstruction detection section 46, and the speeding detection section 48, and derives a degree of danger for comprehensively determining whether there is dangerous driving, and the routine moves on to step 116. For example, at the time of detecting the respective types of dangerous driving, the degrees of danger of the respective types of dangerous driving are computed in the range of 0 to 1, and the average of the degrees of danger of the respective types of dangerous driving is derived as the overall degree of danger. Alternatively, the absence/presence of the detection of each type of dangerous driving may be detected as 0 (not detected) or 1 (detected), and the total of the detection results is derived as the overall degree of danger. Alternatively, at the time of detecting each type of dangerous driving, a score for each type of dangerous driving may be derived, and the total of the scores is computed as the overall degree of danger.

In step 116, the dangerous driving detection aggregation section 50 determines whether or not overall dangerous driving has been detected. In this determination, it is determined whether or not overall dangerous driving has been detected by determining whether or not the derived degree of danger is greater than or equal to a predetermined threshold value. If this determination is affirmative, the routine moves on to step 118, and, if this determination is negative, the routine moves on to step 120.

In step 118, the information aggregation section 40 determines whether or not there is a next video frame. Namely, it is determined whether or not there still remain video frames that are stored in the DB 38. If this determination is affirmative, the routine returns to step 100, and the above-described processings are repeated. The series of processings ends when the judgment becomes negative.

In this way, in the present embodiment, by detecting plural types of dangerous driving that are sudden acceleration/sudden deceleration, non-maintaining of inter-vehicle distance, obstruction of a pedestrian, and speeding, and deriving the overall degree of danger of dangerous driving, the degree of the dangerous driving of the driver may be derived from types of dangerous driving that are detected multilaterally. Accordingly, actual dangerous driving by a driver may be evaluated more properly, as compared with a case in which the degree of danger of driving behavior is computed on the basis of the environment danger degree per object and weighting factors that correspond to the viewing actions of the driver with respect to the objects.

Further, in the present embodiment, because dangerous driving corresponding to the traveling scenario is detected, dangerous driving may be detected by taking into consideration the situation at the time of traveling.

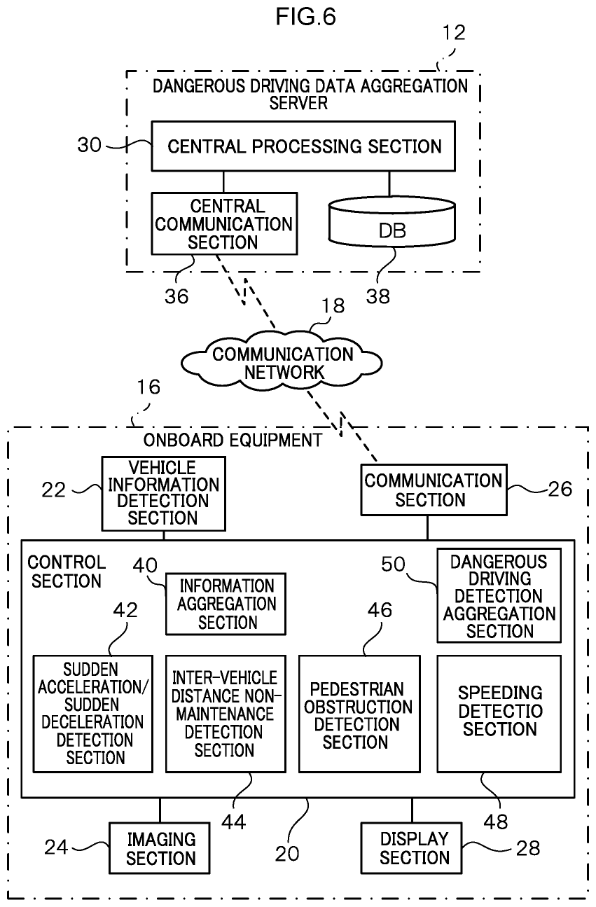

Note that the above-described embodiment describes an example in which the processing of detecting dangerous driving is carried out at the dangerous driving data aggregation server 12, but the present disclosure is not limited to this. For example, a configuration may be made in which the functions of the central processing section 30 of FIG. 2 are provided at the control section 20 of the onboard equipment 16 as illustrated in FIG. 6, and the processing of FIG. 5 is executed at the control section 20. Namely, the functions of the information aggregation section 40, the sudden acceleration/sudden deceleration detection section 42, the inter-vehicle distance non-maintenance detection section 44, the pedestrian obstruction detection section 46, the speeding detection section 48, and the dangerous driving detection aggregation section 50 may be provided at the control section 20. In this case, the information aggregation section 40 acquires vehicle information such as the vehicle speed, acceleration, position information and the like from the vehicle information detection section 22, and acquires video frames from the imaging section 24. Alternatively, these functions may be provided at another external server or the like.

Further, the above embodiment describes, as examples of the plural types of dangerous driving, four types of dangerous driving, which are sudden acceleration/sudden deceleration, non-maintenance of an inter-vehicle distance, obstruction of a pedestrian, and speeding. However, the present disclosure is not limited to this. For example, two types or three types among these four types of dangerous driving may be used. Further, other types of dangerous driving than these four types may be included. Examples of the other types of dangerous driving may include: not stopping at lights, stop signs or intersections, ignoring a traffic signal, road rage, dangerous pulling-over, unreasonable cutting-in, lane changing or left/right turns without signaling, not turning on the lights in the evening, traveling in reverse, interrupting the course of other vehicles (in the overtaking lane or the like), jutting-out from a parking space, parking in a handicap parking spot, parking on the street, driving while looking sideways, falling asleep at the wheel, distracted driving, and the like.

Further, although the processing carried out by the dangerous driving data aggregation server 12 in the above-described respective embodiments is described as software processing carried out by the CPU 30A executing a program, the present disclosure is not limited to this. The processing may be carried out by, for example, hardware such as dedicated electrical circuits or the like, which are processors having circuit that are designed for a dedicated purpose of executing specific processings, such as Graphics Processing Units (GPUs), Application Specific Integrated Circuits (ASICs), Field-Programmable Gate Arrays (FPGAs) and the like. The processing may be executed by one of these various types of processors, or may be executed by combining two or more of the same type or different types of processors (e.g., plural FPGAs, or a combination of a CPU and an FPGA, or the like). Further, the hardware structures of these various types of processors are, specifically, electrical circuits that combine circuit elements such as semiconductor elements and the like. Alternatively, the processing may be performed by a combination of software and hardware. In the case of software processing, the program may be stored on any of various types of storage media such as a Compact Disk Read Only Memory (CD-ROM), a Digital Versatile Disk Read Only Memory (DVD-ROM), a Universal Serial Bus (USB) memory or the like, and distributed.

Moreover, the present disclosure is not limited to the above, and may of course be implemented by being modified in various ways within a scope that does not depart from the gist thereof.

What is claimed is:

1. A dangerous driving detection device comprising:
a memory: and
a processor coupled to the memory, and configured to:
acquire image information, which expresses captured images that are captured by an imaging section provided at a vehicle, and vehicle information that expresses a state of the vehicle;
based on the acquired image information and the acquired vehicle information, detect a plurality of different types of dangerous driving; and
based on results of detection of the plurality of types of dangerous driving, derives a degree of danger of dangerous driving of a driver.

2. The dangerous driving detection device of claim 1, wherein the processor is further configured to identify a traveling scenario based on the image information and the vehicle information, and detect dangerous driving that corresponds to the identified traveling scenario.

3. The dangerous driving detection device of claim 2, wherein the processor is further configured to change a detection threshold value, which is for detecting dangerous driving, to a predetermined detection threshold value in accordance with the traveling scenario, to detect the dangerous driving.

4. The dangerous driving detection device of claim 2, wherein the traveling scenario includes at least one traveling scenario of type of road, weather, time range, or accident occurrence rate at a place of traveling.

5. The dangerous driving detection device of claim 1, wherein the processor is further configured to carry out processing that synchronizes the image information and the vehicle information by performing time matching of the image information and the vehicle information.

6. A dangerous driving detection system comprising:
the dangerous driving detection device of claim 1; and
a vehicle that includes the imaging section and a vehicle information detection section that detects the vehicle information.

7. A dangerous driving detection method comprising:
acquiring image information, which expresses captured images that are captured by an imaging section provided at a vehicle, and vehicle information that expresses a state of the vehicle;
based on the acquired image information and the acquired vehicle information, detecting types of dangerous driving that are respectively different from one another; and
based on results of detection, deriving a degree of danger of dangerous driving of a driver.

8. A non-transitory storage medium that stores a program that is executable by a computer to perform dangerous driving detection processing, the dangerous driving detection processing comprising:
acquiring image information, which expresses captured images that are captured by an imaging section provided at a vehicle, and vehicle information that expresses a state of the vehicle;
based on the acquired image information and the acquired vehicle information, detecting types of dangerous driving that are respectively different from one another; and
based on results of detection, deriving a degree of danger of dangerous driving of a driver.
